(19) United States
(12) Patent Application Publication
(10) Pub. No.: US 2006/0108077 A1
(43) Pub. Date: May 25, 2006

(54) Curtain hoisting clutch apparatus

(76) Inventor: Wen-Jen Wang, Linbian Township (TW)

Correspondence Address: BIRCH STEWART KOLASCH & BIRCH, PO BOX 747, FALLS CHURCH, VA, 22040-0747, US

(21) Appl. No.: 10/995,250

(22) Filed: Nov. 24, 2004

(51) Int. Cl. E06B 9/324

(52) U.S. Cl. 160/178.2

(57) ABSTRACT

An improved curtain hoisting apparatus is wedged to a left end of a track and mainly includes a gear located on the bottom of an anchor body. The gear has a spindle pin movable in an m-shaped channel formed on an inner side of a wedge plate. The spindle pin is allowed to move and anchor in a first channel of the m-shaped channel to loosen a curtain cord for hoisting the curtain panel to a selected elevation. Pulling the curtain cord one more time allows the spindle pin moving from the first channel towards a second channel until anchoring at an outer rim at the left side of the m-shaped channel to brake the curtain cord thereby to halt the curtain panel at the selected elevation. Pulling the curtain cord repeatedly, the curtain panel may be hoisted and halted alternately and easily at selected elevations.

### FIELD OF THE INVENTION

The present invention relates to a curtain hoisting clutch system and particularly an improved curtain hoisting clutch apparatus for extending and hoisting curtain to selected elevations freely.

### BACKGROUND OF THE INVENTION

Window coverings such as curtains, draperies and shade and blinds have been widely used in households and office environments. The opening (hoisting) and closing (extending) of the curtains mostly are done by pulling cords. This type of operation generally is adapted for Venetian blinds or curtains composed of a left and a right panel, but is not adaptable for one piece hoisting shade or curtain. Moreover, in conventional curtain hoisting clutch systems, when the cord is pulled bias to the right and then straightened again, the curtain will be fully extended. Pull the cord bias to the right again, the cord will be halted and the curtain will be rolled to the top end. Such clutch systems can either fully extend the curtain or completely roll the curtain, but cannot control the rolling of the curtain to any desired elevation. Hence their applications are limited.

### SUMMARY OF THE INVENTION

In view of the foregoing disadvantages, the primary object of the invention is to provide an improved curtain hoisting clutch apparatus that allows the curtain extending or hoisting to any selected elevation desired. In the invention, a curtain clutch means is mounted to the left hand side of the track. Pulling the curtain cord once, the curtain panel will be extended clockwise to a selected elevation. Pulling the cord the second time, the curtain panel will be moved up and halted at the selected elevation. By repeating the pulling actions, the curtain may be extended or halted easily at selected elevations.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention, after installation.

FIG. 2 is an exploded view of the invention.

FIG. 3 is a rear cross section of an anchor body of the invention.

FIG. 4 is a front view, partly cutaway, of the anchor body of the invention.

FIG. 5 is a top view of the anchor body of the invention.

FIG. 6 is a schematic view of a spindle pin located at the outer rim on the left side of a m-shaped channel.

FIG. 7 is a schematic view of the spindle pin moving from the outer rim on the left side to a first channel of the m-shaped channel.

FIG. 8 is a schematic view of the spindle pin engaged in first channel of the m-shaped channel.

FIG. 9 is a schematic view of the spindle pin moving from the first channel to a second channel of the m-shaped channel.

FIG. 10 is a schematic view of the spindle pin moving from the second channel to the outer rim on the left side of the m-shaped channel.

FIG. 11 is another schematic view of the spindle pin moving from the second channel to the outer rim on the left side of the m-shaped channel.

FIG. 12 is yet another schematic view of the spindle pin moving from the second channel to the outer rim on the left side of the m-shaped channel.

### DESCRIPTION OF THE PREFERRED EMBODIMENT

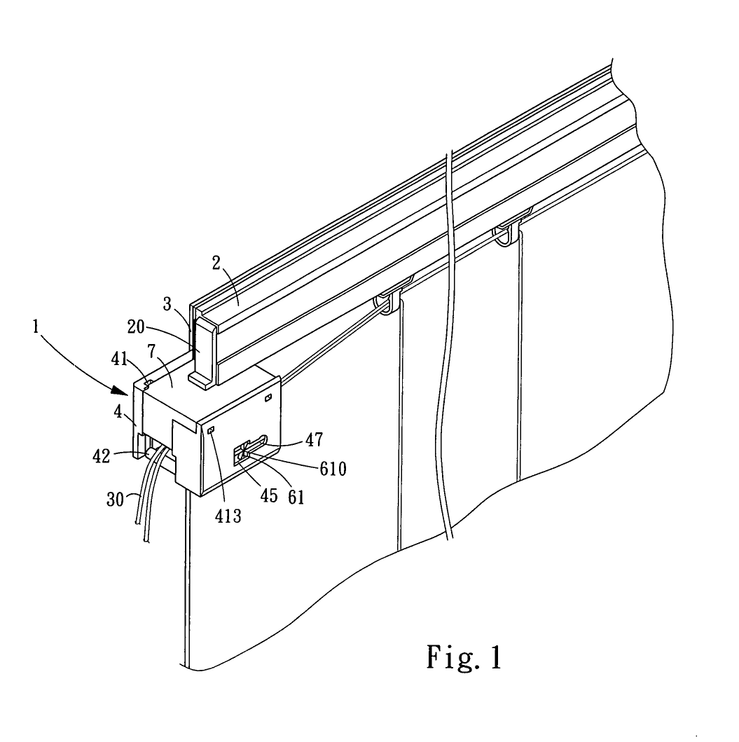

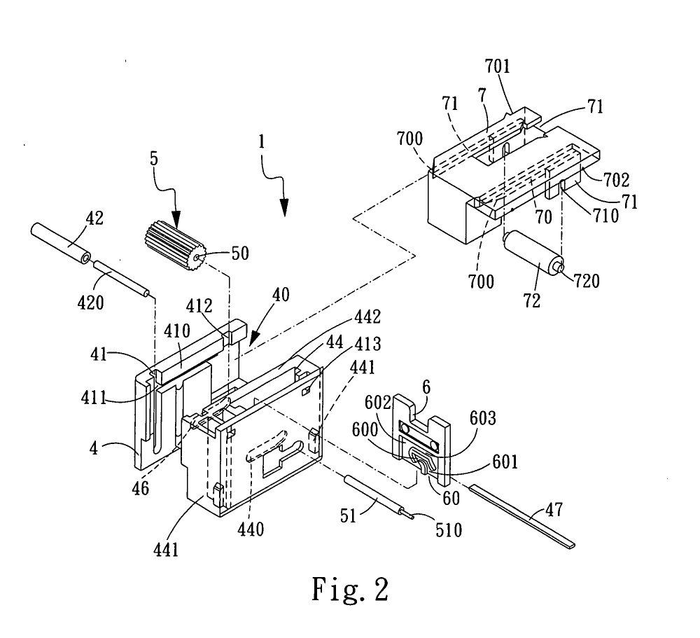

Referring to FIGS. 1 and 2, the curtain hoisting clutch apparatus 1 of the invention is wedged to a lower side of a left end of a track 2 by means of a fastening block 20 to control a moving of a curtain panel 3 located at the rear side of the track 2 through a curtain cord 30. Pulling the curtain cord 30 once, the curtain panel 3 will be hoisted to a selected elevation. Pulling the curtain cord 30 another time, the curtain panel 3 will be halted at the selected elevation. The hoisting clutch apparatus 1 consists of an anchor body 4, a gear 5, a wedge plate 6 and a lid 7.

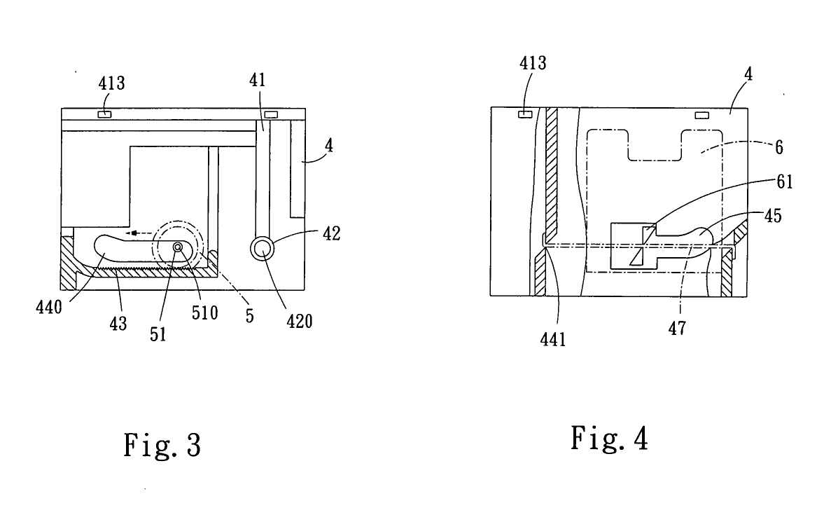

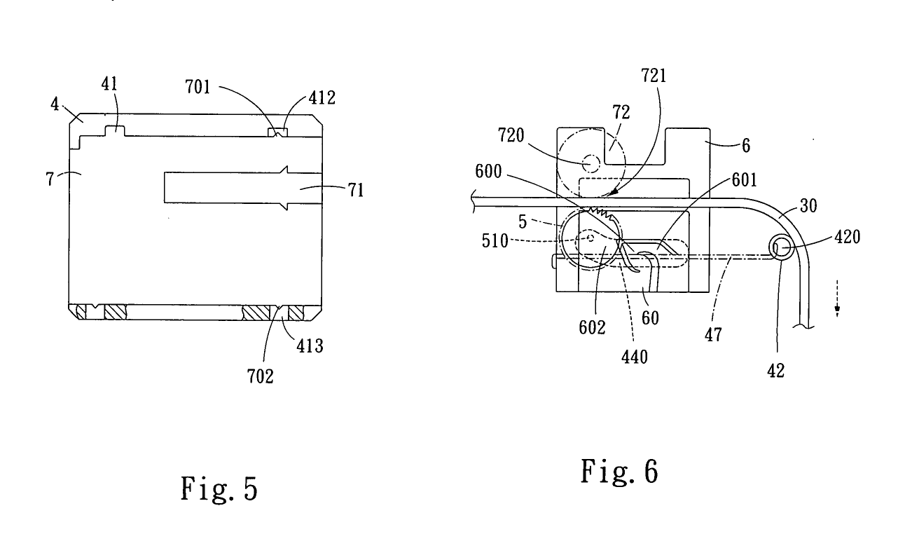

The anchor body 4 is an U-shaped frame having an opening 40 on the top side, and two mating and opposing side walls 410 each has a longitudinal trough 41 for movably coupling with a shaft 420 of a roller 42 and a transverse trough 411 formed proximate to the top side thereof for wedging flanges 70 formed at two sides of the bottom of the lid 7. On the bottom side of the anchor body 4, there is a gear rack 43 engageable with the gear 5 as shown in FIG. 3. The gear 5 has a center hole 50 housed a spindle 51 therein. The spindle 51 has a movable spindle pin 510 formed at a front end which is movable in a m-shaped channel 60 formed on an inner side of the wedge plate 6 which is located in a channel zone 44 formed in the front side of the anchor body 4. At the lower portion of the side wall 410 corresponding to the spindle 51, there is a T-shaped opening 45 which has one end tilted slightly upwards, and a first elongated channel 46. On an outer wall 442 of the channel zone 44 at a lower section there is a second elongated channel 440 formed on. The spindle 51 is movable in the T-shaped opening 45, and the first and second elongated channel 46 and 440. The channel zone 44 further has two ends each has an aperture 441 formed thereon for holding an elastic strip 47 therebetween. The elastic strip 47 is wedged through a gap 610 formed between two opposing triangular blocks 61 located on an outer side of the wedge plate 6 as shown in FIG. 4, and may move the wedge plate 6 up or down.

The gear 5 has the center hole 50 housed the spindle 51 therein with the spindle pin 510 formed at the front end of the spindle 51. The spindle 51 is movable in the first elongated channel 46 and the second elongated channel 440 formed respectively on the side wall 410 of the anchor body 4 and the outer wall 442 of the channel zone 44. The gear 5 has teeth 500 on the periphery to engage with the gear rack 43 at the bottom of the anchor body 4 such that the spindle pin 510 is movable reciprocally.

The wedge plate 6 has the m-shaped channel 60 formed on the inner side at a lower portion which includes a first channel 600 and a second channel 601 to allow the spindle pin 510 moving therein. The triangular blocks 61 are located on the outer side of the wedge plate 6 corresponding to the m-shaped channel 60 and have the gap 610 formed therebetween to wedge the elastic strip 47. The elastic strip 47, through its elastic force, may move the wedge plate 6 up or down.

The lid 7 has a T-shaped ledge 71 formed on the top side thereof for wedging the fastening block 20 of the track 2. The wedging flanges 70 formed at two sides of the bottom of the lid 7 have respectively a slant surface 700 at the front end to slide and wedge in the transverse troughs 411 of the side walls-410 of the anchor body 4. The flanges 70 have lugs 710, 702 jutting from two ends to engage with notches 412, 413 formed on the top rim of the mating side walls 410. There is a T-shaped ledge 71 extended downwards from one side of the flange 70. The T-shaped ledge 71 has a longitudinal notch 710 formed on the side wall thereof to engage with a roller stub shaft 720 extending from either end of a roller 72. The roller 72 is located above the gear 5 and turnable in an opposite direction relative to the gear 5.

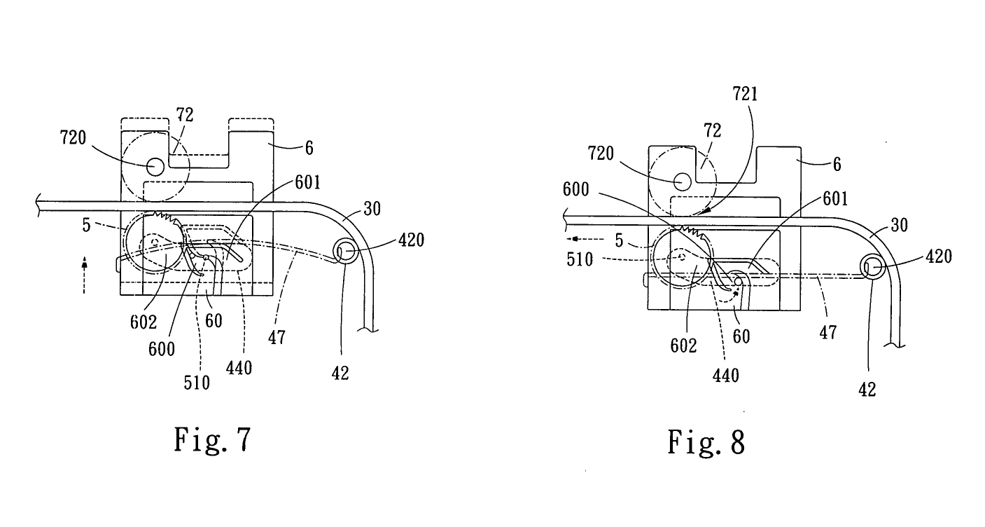

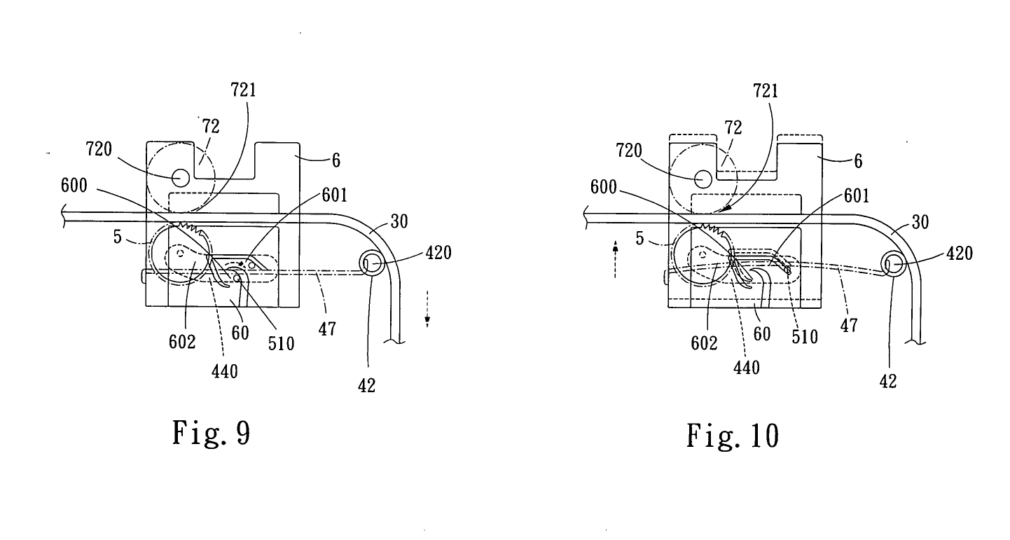

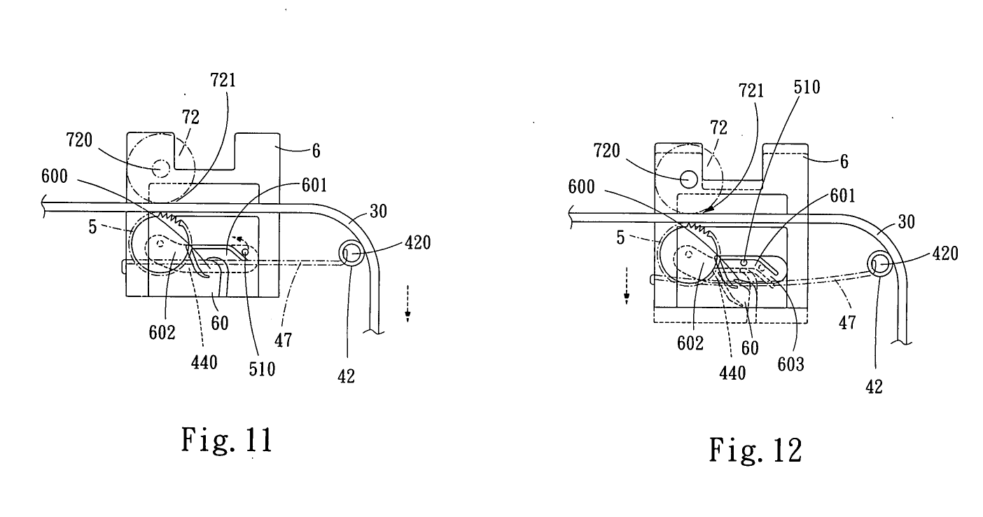

When the curtain hoisting clutch apparatus 1 thus constructed is in use, the spindle pin 510 of the gear 5 is moved on the gear rack of the anchor body from an outer rim 602 at the left side of the m-shaped channel 60 of the wedge plate 6 to the first channel 600 and anchoring there as shown in FIGS. 6, 7 and 8, the elastic strip 47 on the outer side of the wedge plate 6 will move the wedge plate 6 from a higher elevation to a lower and original elevation shown in FIG. 8 to increase a gap 721 formed between the gear 5 and roller 72 located at one side of the lid 7 thereby to loosen the cord 30 so that the curtain panel 3 may be hoisted to an elevation desired. Pulling the curtain cord 30 once more shown in FIG. 9, the spindle pin 510 of the gear 5 will be moved from the first channel 600 towards the second channel 601 then moved to an upper rim 603 of the m-shaped channel 60 to depress the wedge plate 6 downwards as shown in FIGS. 10, 11, 12 and anchor at the outer rim 602 at the left hand side; the wedge plate 6 will be moved by the elastic strip 47 from a lower elevation to a higher and original elevation shown in FIG. 6 to decrease the gap 721 between the gear 5 and roller 72 to brake the curtain cord 30 so that the curtain panel 3 will be halted at the elevation desired. Repeat the pulling of the curtain cord 30 once more, the curtain panel 3 may be hoisted again, and pulling the curtain cord 30 another time, the curtain panel 3 will be halted. Thus the curtain panel 3 may be controlled easily to hoist and halt at any elevation desired.

What is claimed is:

1. An improved curtain hoisting apparatus wedged to a lower side of a left end of a track by means of a fastening block to control the moving of a curtain panel located at a rear side of the track such that the curtain panel will be hoisted to a selected elevation by pulling a curtain cord once, and halted at the selected elevation by pulling the curtain cord one more time, the curtain hoisting apparatus comprising an anchor body, a gear, a wedge plate and a lid; wherein:
the anchor body is an U-shaped frame having an opening on the top side thereof, two mating and opposing side walls each having a longitudinal trough for movably coupling with a shaft of a roller and a transverse trough proximate to a top end thereof for wedging flanges formed at two sides of the bottom of the lid, and a gear rack located on the bottom side of the anchor body engageable with the gear; the gear having a center hole housed a spindle therein, the spindle having a front end formed a movable spindle pin which is movable in a m-shaped channel formed on an inner side of the wedge plate which is located in a channel zone formed in a front side of the anchor body, the side wall corresponding to the spindle having a lower portion formed with a T-shaped opening which has one, end tilted slightly upwards and a first elongated channel, the channel zone having an outer wall formed with a second elongated channel, the spindle being movable in the T-shaped opening, the first elongated channel and the second elongated channel, the channel zone further having two ends each has an aperture formed thereon for holding an elastic strip therebetween, the elastic strip being wedged through a gap formed between two opposing triangular blocks located on an outer side of the wedge plate for moving the wedge plate up or down;
the gear has the center hole housed the spindle which has the spindle pin formed at the front end thereof, the spindle being movable in the first elongated channel and the second elongated channel formed respectively on the side wall and the outer wall of the anchor body and the channel zone, the gear having teeth formed on the periphery thereof to engage with the gear rack at the bottom of the anchor body such that the spindle pin is movable reciprocally;
the wedge plate has the m-shaped channel formed on an inner side at a lower portion thereof including a first channel and a second channel to allow the spindle pin moving therein, the triangular blocks being located on the outer side of the wedge plate corresponding to the m-shaped channel and having the gap formed therebetween to wedge the elastic strip for moving the wedge plate up or down; and
the lid has a T-shaped slot formed on the top side thereof for wedging the fastening block of the track, the wedging flanges formed at two sides of the bottom of the lid having respectively a slant surface at two ends thereof to slide and wedge in the transverse troughs of the mating side walls of the anchor body, the flanges further having jutting lugs formed at two ends thereof to engage with notches formed on a top rim of the side walls, and a T-shaped ledge extended downwards from one side thereof, the T-shaped ledge having a longitudinal notch formed on a side wall thereof to engage with a roller stub shaft extending from either end of a roller to allow the roller locating above the gear and turning in an opposite direction relative to the gear;
wherein the spindle pin of the gear is allowed to move from an outer rim of the m-shaped channel of the wedge plate to the first channel and anchoring there, and the elastic strip on the outer side of the wedge plate being allowed to move the wedge plate from a higher elevation to a lower and an original elevation to increase a gap between the gear and the roller located at the one side of the lid thereby to loosen the curtain cord for hoisting the curtain panel to a selected elevation; the spindle pin of the gear also is allowed to move from the first channel towards the second channel then move to an upper rim of the m-shaped channel and anchor at the outer rim at the left hand side of the m-shaped channel to depress the wedge plate downwards by pulling the curtain cord one more time such that the elastic strip moves the wedge plate from a lower elevation to a higher and original elevation to decrease the gap between the gear and the roller to brake the curtain cord for halting the curtain panel at the selected elevation; the curtain panel being allowed to hoist and halt alternately at selected elevations by repeatedly pulling the curtain cord.
